(19) United States
(12) Patent Application Publication
(10) Pub. No.: US 2021/0139360 A1
(43) Pub. Date: May 13, 2021

(54) RECYCLING SYSTEM FOR TREATMING SEWAGE OF ECOLOGICAL FARM

(71) Applicant: PowerChina Huadong Engineering Corporation Limited, Hangzhou (CN)

(72) Inventors: Sheng SHENG, Hangzhou (CN); Huabin LI, Hangzhou (CN); Yunling DU, Hangzhou (CN); Shuxin WU, Hangzhou (CN); Linge XU, Hangzhou (CN); Yi JIN, Hangzhou (CN); Jianfeng LI, Hangzhou (CN)

(21) Appl. No.: 16/680,676

(22) Filed: Nov. 12, 2019

(51) Int. Cl. C02F 3/32; C02F 9/00; C02F 1/00

(52) U.S. Cl. CPC C02F 3/327; C02F 1/008; C02F 9/00

(57) ABSTRACT

Disclosed is a recycling system for treating sewage of an ecological farm, including an external water source, a living area producing domestic sewage, a culture area producing breeding sewage and a farmland area producing agricultural drainage. The external water source feeds water to an ecological river, a water-saving irrigation system of the farmland area, the living area and the culture area through a water-diversion system. A first channel configured to discharge the domestic sewage from the living area is communicated with the water-saving irrigation system through a domestic sewage treatment system. A second channel configured to discharge the breeding sewage from the culture area is communicated with the water-saving irrigation system through a breeding sewage treatment system.

### TECHNICAL FIELD

The present application relates to eco-environmental engineering, and more particularly to a recycling system for treating sewage of an ecological farm, which can be applied to the purification and recycling of ecological farm wastewater.

### BACKGROUND OF THE INVENTION

Ecological farm generally aims to be a comprehensive leisure land combining modern technology with agriculture, which is centered on green, clean and organic energy and agricultural products, and also has various functions such as leisure tourism, agricultural production and technology display. Water plays a key role in the construction of an ecological farm, specifically, the ecological farm requires water mainly to meet the needs of daily life, production and ecological landscapes.

According to the source of sewage and the type of pollutants, ecological farms generally produce three kinds of sewage, including domestic sewage, breeding sewage and agricultural drainage. Among them, the domestic sewage is mainly generated in daily life, and is divided into kitchen wastewater, washing wastewater and excretion wastewater. The domestic sewage contains various food residues, proteins, oils, detergents and disinfectants, and the main pollution indicators include chemical oxygen demand (COD), ammonia nitrogen (NH₃—N), biochemical oxygen demand (BOD), total phosphorus (TP) and linear alkylbenzene sulfonates (LAS). The breeding sewage is mainly derived from the excrement of livestock and poultry and the wastewater generated from site cleaning, and the main pollution indicators include COD, NH₃—N and TP. The main pollutants in the agricultural drainage are derived from fertilizers and agricultural chemicals used in farming activities, and the main pollution indicators include total nitrogen (TN), NH₃—N, TP and COD.

An object of sewage treatment is to achieve the reduction of resource consumption, the reuse of products and the recycling of waste, where the utilization of water resources is required to be transformed from a one-way linear water consumption system (water supply-use-drainage) to a closed-loop water recycling system (water supply-use-drainage-reuse). Currently, some measures have been applied to the sewage treatment in different ecological farms, such as the construction of septic tanks, biogas tanks, contact oxidation tanks, ecological filter, stabilization tanks and constructed wetlands and the application of land infiltration, which can be used to purify sewage and reduce pollution, meeting the discharge standard. However, so far, there is still a lack of complete systematic solutions for comprehensive recycling of water. Meanwhile, since the comprehensive recycling of water requires water of higher quality, and the sewage treated by traditional measures which can meet the discharge standard may fail to meet the requirements for water quality under the new conditions, there is a need to develop a more effective technical approach for various aspects of sewage treatment.

On the one hand, ecological farms require a large amount of water to meet the needs of the production, living and ecological landscape, and a large number of nitrogen and phosphate fertilizers are necessary for agricultural farming. On the other hand, various sewages produced from ecological farms contain a large number of nutrients, such as organic matters, nitrogen and phosphorus, which need to be treated before the drainage, so that not only the nutrients required by the crops are wasted but also pollution may be brought to the external water bodies.

### SUMMARY OF THE INVENTION

An object of the application is to provide a highly-efficient and widely-applicable recycling system for treating sewage of an ecological farm to solve the above problems, where the system is capable of treating and recycling domestic sewage, breeding sewage and agricultural drainage from the ecological farm, reducing water consumption and pollutant emissions.

This application provides a recycling system for treating sewage of an ecological farm, comprising:

an external water source;

a living area producing domestic sewage;

a culture area producing breeding sewage; and

a farmland area producing agricultural drainage;

wherein, the external water source feeds water to an ecological river, a water-saving irrigation system of the farmland area, as well as the living area and the culture area through a water-diversion system;

a first channel configured to discharge the domestic sewage from the living area is communicated with the water-saving irrigation system through a domestic sewage treatment system;

a second channel configured to discharge the breeding sewage from the culture area is communicated with the water-saving irrigation system through a breeding sewage treatment system;

a third channel configured to discharge the agricultural drainage from the farmland area are communicated with the ecological river and an ecological pond through an agricultural drainage purifying system; and a valve I-A and a valve I-B are respectively provided at the ecological river and the ecological pond;

the ecological river is communicated with the ecological pond and a downstream water system; and a valve II-A and a valve II-B are respectively provided at the ecological pond and the downstream water system;

the ecological pond is communicated with the water-saving irrigation system and the downstream water system; and a valve III-A and a valve III-B are respectively provided at the water-saving irrigation system and the downstream water system.

The water-diversion system comprises a water purification device, a pumping station, a reservoir, a water delivery pipeline and a water diversion channel;

the external water source feeds water to the living area and the culture area sequentially through the water purification device, the pumping station, the reservoir and the water delivery pipeline; and the external water source feeds water to the water-saving irrigation system of the farmland area through the water diversion channel.

The domestic sewage treatment system comprises a first sewage pipe network, a septic tank and a constructed wetland; the domestic sewage from the living area sequentially passes through the first sewage pipe network, the septic tank and the constructed wetland to feed water to the water-saving irrigation system of the farmland area.

The constructed wetland is a vertical subsurface flow constructed wetland.

The breeding sewage treatment system comprises a second sewage pipe network, a grille, an anaerobic tank, an aerobic tank, a subsurface flow constructed wetland and a surface flow constructed wetland; the breeding sewage from the culture area sequentially passes through the second sewage pipe network, the grille, the anaerobic tank, the aerobic tank, the subsurface flow constructed wetland and the surface flow constructed wetland to feed water to the water-saving irrigation system of the farmland area.

The subsurface flow constructed wetland is a combination of a horizontal subsurface flow constructed wetland and a vertical subsurface flow constructed wetland.

The agricultural drainage purifying system comprises an ecological ditch.

The ecological ditch is backfilled with gravel filler and planted with aquatic plants.

The beneficial effects of the application are described as follows.

In the application, the domestic sewage and the breeding sewage respectively treated by the domestic sewage treatment system and the breeding sewage treatment system can be applied to the irrigation for the farmland area, which can make full use of the nutrients in tail water such as nitrogen, phosphorus and organic matters, and avoid the pollution caused by the tail water discharge, thereby achieving both economic and ecological benefits. After treated by the agricultural drainage purifying system, the agricultural drainage is temporarily stored in the ecological pond as ecological landscape water, and when agricultural irrigation is needed, this part of water can be reused, realizing the water recycling and zero sewage discharge. The ecological river in the application serves as a discharge channel for rainfall flood to avoid the damage caused by flood to the farmland area, the ecological pond and other facilities, thereby ensuring the safety of the ecological farm.

### BRIEF DESCRIPTION OF THE DRAWINGS

FIG. 1 is a schematic diagram showing a recycling system for treating sewage of an ecological farm in an embodiment of the invention.

FIG. 2 is a schematic diagram showing a water-diversion system in an embodiment of the invention.

FIG. 3 is a schematic diagram showing a domestic sewage treatment system in an embodiment of the invention.

FIG. 4 schematically shows a breeding sewage treatment system in an embodiment of the invention.

FIG. 5 is a schematic diagram showing the irrigation and drainage in a farmland area according to an embodiment in the invention.

### DETAILED DESCRIPTION OF EMBODIMENTS

As shown in FIG. 1, this embodiment provides a recycling system for treating sewage of an ecological farm, including an external water source 1, and water-consuming areas including a living area 2, a culture area 3, a farmland area 4, an ecological river 7, as well as a water-diversion system 6, a domestic sewage treatment system 201, a breeding sewage treatment system 301, an agricultural drainage purifying system 402, a water-saving irrigation system 401, an ecological pond 8 and a downstream water system 9.

In this embodiment, the external water source 1 feeds water to respective water-consuming areas through the water-diversion system 6. The water-saving irrigation system 401 is provided in the farmland area 4 to improve the utilization efficiency of water and fertilizer as well as reduce the agricultural drainage. The water transported to the farmland area 4 by the water-diversion system 6 is used for irrigation through the water-saving irrigation system 401.

A first channel configured to discharge the domestic sewage from the living area 2 is communicated with the water-saving irrigation system 401 of the farmland area 4 through the domestic sewage treatment system 201. A second channel configured to discharge the breeding sewage from the culture area 3 is communicated with the water-saving irrigation system 401 of the farmland area 4 through the breeding sewage treatment system 301. The domestic sewage produced in the living area 2 and the breeding sewage produced in the culture area are respectively treated by the domestic sewage treatment system 201 and the breeding sewage treatment system 301, then are conveyed to the farmland area for re-utilization.

A third channel configured to discharge the agricultural drainage from the farmland area 4 is respectively communicated with the ecological river 7 and the ecological pond 8 through the agricultural drainage purifying system 402, and a valve I-A and a valve I-B are respectively provided at the ecological river 7 and the ecological pond 8. During the non-flood period, the agricultural drainage is purified by the agricultural drainage purifying system 402 and then temporarily stored in the ecological pond 8. During the flood period, the valve I-A is opened to discharge water through the ecological river 7.

The ecological river 7 is communicated with the ecological pond 8 and a downstream water system 9, where a valve II-A and a valve II-B are respectively provided in the ecological pond 8 and the downstream water system 9. During the non-flood period, water in the ecological river 7 flows into the ecological pond 8 to improve the hydrodynamic conditions and water quality of the ecological pond 8. During the flood period, the valve II-B is opened to discharge the water to the downstream water system 9.

In the embodiment, the ecological pond 8 is communicated with the water-saving irrigation system 401 and the downstream water system 9, where a valve III-A and a valve III-B are respectively provided in the water-saving irrigation system 401 and the downstream water system 9. During the non-flood period, the water stored in the ecological pond 8 is reused when the agricultural irrigation is needed. During the flood period, the valve III-B is opened to discharge the water to the downstream water system 9.

As shown in FIG. 2, the water-diversion system 6 includes a water purification device 601, a pumping station 602, a reservoir 603, a water delivery pipeline 604 and a water diversion channel 605. The external water source 1 is purified by the water purification device 601, then lifted to the reservoir 603 through the pumping station 602, and conveyed through the water delivery pipeline 604 to the water-consuming areas such as the living area 2 and the culture area 3 to ensure the water quality and water pressure. While for the farmland area 4, water is transported by gravity to pass through the water diversion channel 605. The water purification device 601 includes desilting unit, flocculation unit, rough filtration unit, slow filtration unit and disinfection unit. The reservoir 603 has a reinforced concrete structure. The water delivery pipeline 604 is made of PE material. The water diversion channel 605 has a structure of soil groove, masonry, bricklaying, concrete precast blocks and cast-in-place concrete, and the cross-section of the water diversion channel 605 is trapezoidal, rectangular, U-shaped, or the like.

As shown in FIG. 3, the domestic sewage treatment system 201 includes a first sewage pipe network 2011, a septic tank 2012 and a constructed wetland 2013. The domestic sewage from the living area 2 sequentially passes through the first sewage pipe network 2011, the septic tank 2012 and the constructed wetland 2013 to feed the water-saving irrigation system 401 of the farmland area 4. The first sewage pipe network 2011 is made of PVC pipe, PE pipe, reinforced concrete, etc. The septic tank 2012 has a reinforced concrete structure. The constructed wetland 2013 is a vertical subsurface flow constructed wetland 3015-2 of which the wall and the bottom are made of reinforced concrete. In addition, the vertical subsurface flow constructed wetland 3015-2 is filled with gravel, volcanic rock, zeolite, ceramsite and other fillers. A water distribution pipe is made of UPVC material, and some aquatic plants such as reed and canna are planted on the fillers.

As shown in FIG. 4, the breeding sewage treatment system 301 includes a second sewage pipe network 3011, a grille 3012, an anaerobic tank 3013, an aerobic tank 3014, a subsurface flow constructed wetland 3015 and a surface flow constructed wetland 3016. The breeding sewage from the culture area 3 sequentially passes through the second sewage pipe network 3011, the grille 3012, the anaerobic tank 3013, the aerobic tank 3014, the subsurface flow constructed wetland 3015 and the surface flow constructed wetland 3016 to feed water to the water-saving irrigation system 401 of the farmland area 4. The second sewage pipe network 3011 is made of PVC, reinforced concrete, etc. The grille 3012 is formed by rectangular steel bars. The anaerobic tank 3013 and the aerobic tank 3014 are made of reinforced concrete. The subsurface flow constructed wetland 3015 is a combination of a horizontal subsurface flow constructed wetland 3015-1 and a vertical subsurface flow constructed wetland 3015-2, of which the wall and the bottom are made of reinforced concrete. Moreover, the horizontal subsurface flow constructed wetland 3015-1 and the vertical subsurface flow constructed wetland 3015-2 are filled with gravel, volcanic rock, zeolite, ceramsite and other fillers. A water distribution pipe made of UPVC is provided, and aquatic plants such as reed and canna are planted on the fillers.

As shown in FIG. 5, the agricultural drainage purifying system 402 utilizes an ecological ditch 4021 which has a structure of soil groove, masonry, bricklaying, concrete precast blocks and cast-in-place concrete, and the cross-section of the water ecological ditch 4021 is trapezoidal, rectangular, U-shaped, or the like. The ecological ditch 4021 is filled with sand and gravel, and aquatic plants such as calamus and canna are planted on the fillers.

In this embodiment, after respectively treated by the domestic sewage treatment system 201 and the breeding sewage treatment system 301, the domestic sewage and the breeding sewage then enter the water-saving irrigation system 401 together with the external water source 1. The water-saving irrigation system 401 is operated in a manner of spray irrigation or drip irrigation. The ecological pond 8 has a depth of 1-2 m, and is filled with sand and gravel at a bottom thereof. Moreover, some emergent plants such as reeds, canna and lotus are planted in shallow water and submerged plants such as Vallisneria spiralis and hornwort are planted in deep water.

In the actual operation, the agricultural drainage is gathered in the ecological ditch 4021 and then enters the ecological pond 8 for purification and temporary storage. The water stored in the ecological pond 8 is reused when the agricultural irrigation is needed. During the flood period, the agricultural drainage gathered at the ecological ditch 4021 is directly discharged to the downstream water system 9 through the ecological river 7 without entering the ecological pond 8, protecting the ecological pond 8 from being damaged by the flood.

What is claimed is:

1. A recycling system for treating sewage of an ecological farm, comprising:
an external water source;
a living area producing domestic sewage;
a culture area producing breeding sewage; and
a farmland area producing agricultural drainage;
wherein:
the external water source feeds water to an ecological river, a water-saving irrigation system of the farmland area, the living area and the culture area through a water-diversion system;
a first channel configured to discharge the domestic sewage from the living area is communicated with the water-saving irrigation system through a domestic sewage treatment system;
a second channel configured to discharge the breeding sewage from the culture area is communicated with the water-saving irrigation system through a breeding sewage treatment system;
a third channel configured to discharge the agricultural drainage from the farmland area are communicated with the ecological river and an ecological pond through an agricultural drainage purifying system; and a valve I-A and a valve I-B are respectively provided at the ecological river and the ecological pond;
the ecological river is communicated with the ecological pond and a downstream water system; and a valve II-A and a valve II-B are respectively provided at the ecological pond and the downstream water system;
the ecological pond is communicated with the water-saving irrigation system and the downstream water system; and a valve III-A and a valve III-B are respectively provided at the water-saving irrigation system and the downstream water system.

2. The recycling system of claim 1, wherein the water-diversion system comprises a water purification device, a pumping station, a reservoir, a water delivery pipeline and a water diversion channel;
the external water source feeds water to the living area and the culture area sequentially through the water purification device, the pumping station, the reservoir and the water delivery pipeline; and
the external water source feeds water to the water-saving irrigation system of the farmland area through the water diversion channel.

3. The recycling system of claim 1, wherein the domestic sewage treatment system comprises a first sewage pipe network, a septic tank and a constructed wetland; the domestic sewage from the living area sequentially passes through the first sewage pipe network, the septic tank and the constructed wetland to feed water to the water-saving irrigation system of the farmland area.

4. The recycling system of claim 3, wherein the constructed wetland is a vertical subsurface flow constructed wetland.

5. The recycling system of claim 1, wherein the breeding sewage treatment system comprises a second sewage pipe network, a grille, an anaerobic tank, an aerobic tank, a subsurface flow constructed wetland and a surface flow constructed wetland; the breeding sewage from the culture area sequentially passes through the second sewage pipe network, the grille, the anaerobic tank, the aerobic tank, the subsurface flow constructed wetland and the surface flow constructed wetland to feed water to the water-saving irrigation system of the farmland area.

6. The recycling system of claim 5, wherein the subsurface flow constructed wetland is a combination of a horizontal subsurface flow constructed wetland and a vertical subsurface flow constructed wetland.

7. The recycling system of claim 1, wherein the agricultural drainage purifying system comprises an ecological ditch.

8. The recycling system of claim 7, wherein the ecological ditch is backfilled with gravel filler and planted with aquatic plants.
